(19) United States
(12) Patent Application Publication
(10) Pub. No.: US 2021/0205641 A1
(43) Pub. Date: Jul. 8, 2021

(54) Back Carrier and Breathing Apparatus

(71) Applicants: AIR WATER SAFETY SERVICE INC., Kobe-shi, Hyogo (JP); SHIGEMATSU WORKS CO., LTD., Tokyo (JP)

(72) Inventors: Shinji YAMAMOTO, Kobe-shi, Hyogo (JP); Takushi DOI, Kobe-shi, Hyogo (JP); Masashi YOKOYAMA, Kobe-shi, Hyogo (JP); Nobuo SHIGEMATSU, Kita-ku, Tokyo (JP); Kenichi ONO, Saitama-shi, Saitama (JP); Hiroyuki IDE, Saitama-shi, Saitama (JP); Masaru FUKUDA, Saitama-shi, Saitama (JP)

(73) Assignees: AIR WATER SAFETY SERVICE INC., Kobe-shi, Hyogo (JP); SHIGEMATSU WORKS CO., LTD., Tokyo (JP)

(21) Appl. No.: 17/059,895

(22) PCT Filed: May 28, 2019
(86) PCT No.: PCT/JP2019/021133

§ 371 Date: Nov. 30, 2020

(30) Foreign Application Priority Data
May 30, 2018 (JP) 2018-103688

(51) Int. Cl. A62B 25/00; A62B 7/02; A62B 9/02; A62B 18/02

(52) U.S. Cl. CPC A62B 25/00; A62B 18/02; A62B 9/02; A62B 7/02

(57) ABSTRACT

There is provided a back carrier that does not hinder the movement of a wearer. A back carrier having a gas cylinder attached thereto, and carried on wearer's back, the back carrier including: a main body to which the gas cylinder is attached; and an adjuster including a regulator and a pressure demand valve attached to the main body and integrated with each other.

### TECHNICAL FIELD

The present disclosure relates to a back carrier.

### BACKGROUND ART

Firefighters perform rescue operations in dangerous places such as a site of a fire. Therefore, firefighters wear breathing apparatuses when performing rescue operations.

As to such a breathing apparatus, U.S. Pat. No. 5,000,174 (PTL 1) discloses a positive pressure breathing apparatus.

### CITATION LIST

### Patent Literature

PTL 1: U.S. Pat. No. 5,000,174

SUMMARY OF INVENTION

### Technical Problem

A conventional breathing apparatus has, in some cases, made it difficult for a firefighter who is a wearer to move.

### Solution to Problem

According to an aspect, there is provided a back carrier having a cylinder attached thereto, and carried on wearer's back, the back carrier including: a main body; and an adjuster including a regulator and a pressure demand valve attached to the main body and integrated with each other.

In the back carrier configured as described above, the regulator and the pressure demand valve are provided on the main body, and thus, these valves are not attached to a facepiece and a belt provided on a chest portion of the back carrier of a wearer. As a result, the movement of the wearer is not hindered. Furthermore, the regulator and the pressure demand valve are integrated with each other, and thus, these valves are not separated from each other and the occurrence of a failure can be suppressed. Furthermore, the adjuster can be made compact. When the regulator and the pressure demand valve are separated from each other, it is necessary to connect the regulator and the pressure demand valve by a medium-pressure hose. In this case, length corresponding to a connector, a fitting for joining the connector and a hose, and the hose is required. This results in an increase in required space and an increase in mass, and thus, ease of operation is lost.

The main body includes an upper portion located on neck side of a wearer and a lower portion located on waist side of the wearer, and the regulator and the pressure demand valve are provided in the lower portion of the main body. In this case, the regulator and the pressure demand valve, which are heavy, are both provided in the lower portion, and thus, the movement of the wearer is not hindered.

The main body is provided with a groove extending from the upper portion to the lower portion, and a pressure detection line that detects pressure in the facepiece and a gas supply line that feeds gas into the facepiece are arranged in the groove. In this case, the pressure detection line and the gas supply line are provided in the groove, and thus, contact of the pressure detection line and the intake line with the wearer and an external article can be prevented. As a result, the movement of the wearer is not hindered.

A guide path that guides gas of the cylinder from outside the main body to inside the main body is provided between the gas cylinder and the regulator, and the guide path is rotatable along plural axes. In this case, the guide path is rotatable along the plural axes, and thus, the gas cylinder and the guide path can be connected, regardless of the size of the gas cylinder.

A breathing apparatus includes: any back carrier described above; and a facepiece supplied with gas from the back carrier and covering a face of a wearer.

### BRIEF DESCRIPTION OF DRAWINGS

FIG. 1 is a perspective view of a facepiece 11 according to an embodiment.

FIG. 2 is a perspective view of a wearer 201 wearing facepiece 11 and a back carrier 300 according to the embodiment.

FIG. 3 is a perspective view of wearer 201 wearing facepiece 11 and back carrier 300 according to the embodiment.

FIG. 4 is a perspective view of a rotation mechanism 100 and a front surface plate 31 to which rotation mechanism 100 is attached according to the embodiment.

FIG. 5 is a perspective view of rotation mechanism 100 according to the embodiment.

FIG. 6 is a cross-sectional view taken along line VI-V1 in FIG. 4.

FIG. 7 is a cross-sectional view taken along line VII-VII in FIG. 5.

FIG. 8 is an exploded perspective view of rotation mechanism 100 according to the embodiment.

FIG. 9 is a perspective view of rotation mechanism 100 and front surface plate 31 to which rotation mechanism 100 is attached according to the embodiment.

FIG. 10 is a perspective view of back carrier 300 according to the embodiment.

FIG. 11 shows a state in which a gas cylinder 250 is mounted on back carrier 300.

FIG. 12 shows a state in which gas cylinder 250 is mounted on back carrier 300.

FIG. 13 shows a state in which gas cylinder 250 is mounted on back carrier 300.

FIG. 14 shows a state in which gas cylinder 250 is mounted on back carrier 300.

FIG. 15 shows a gas supply line 210 and a pressure detection line 220.

FIG. 16 is a cross-sectional view of gas supply line 210 and pressure detection line 220.

FIG. 17 is a perspective view of back carrier 300.

FIG. 18 is a perspective view of back carrier 300, with a drain plug cover 380 removed.

FIG. 19 is a perspective view showing an internal structure of back carrier 300, with a back plate 330b removed.

FIG. 20 is a perspective view showing an internal structure of back carrier 300, with a drain plug 430 removed from a case 401.

FIG. 21 is a perspective view showing an internal structure of back carrier 300, with an adjuster 450 removed from back plate 330b.

FIG. 22 is a cross-sectional view showing an internal structure of a pressure demand valve 400 and a regulator 460.

FIG. 23 is a cross-sectional view showing a state in which medium-pressure air is flowing to a gas supply port 423 in pressure demand valve 400 in accordance with an amount of breathing.

FIG. 24 is a cross-sectional view taken along line XXIV-XXIV in FIG. 22.

FIG. 25 shows wearer 201, with a neck guard (Shikoro) 240 lifted up.

### DESCRIPTION OF EMBODIMENTS

Each embodiment according to the present invention will be described hereinafter with reference to the drawings. In the following description, the same parts and components are denoted by the same reference characters. Their names and functions are also the same. Therefore, detailed description about them will not be repeated.

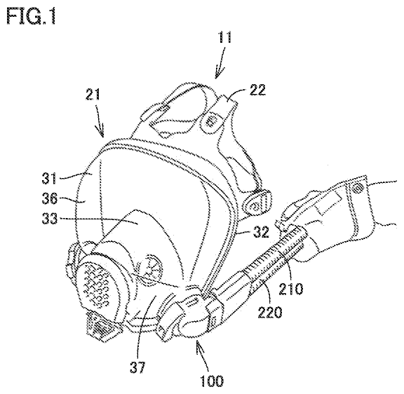

FIG. 1 is a perspective view of a facepiece 11 according to an embodiment.

Facepiece 11 is used in a state of being mounted on a head of a human body. Facepiece 11 includes a facepiece main body 21 that covers a face of a wearer in the mounted state, and a head strap 22 for fixing facepiece main body 21 to a head of the wearer in the mounted state.

Facepiece main body 21 includes a front surface plate 31 that is a colorless and transparent plate-like member having a size that can cover the face of the human body, and a support 32 that supports front surface plate 31 in front of the face of the wearer with an adequate space from the face of the wearer in the mounted state. Front surface plate 31 is also referred to as “eyepiece”.

Hereinafter, one surface of front surface plate 31 in the thickness direction that is directed toward the face of the wearer in the mounted state will be referred to as “inner surface”, and a surface opposite to the inner surface will be referred to as “outer surface”.

Front surface plate 31 includes an upper portion 36 arranged to face a substantially upper half of the face of the wearer in the mounted state, and a lower portion 37 connecting to a lower end of upper portion 36 and arranged to face a substantially lower half of the face of the wearer in the mounted state. Upper portion 36 and lower portion 37 are formed to connect to each other in a bent manner. Specifically, upper portion 36 and lower portion 37 are formed such that lower portion 37 is bent toward the inner surface side with respect to upper portion 36.

Each of upper portion 36 and lower portion 37 is formed to have a smoothly curved shape so as to be convex in a direction away from the face of the wearer between right and left ends in the mounted state. In addition, a through hole passing through lower portion 37 in the thickness direction is formed in a central portion of lower portion 37 between the right and left ends.

A nosecup holding portion to which one end of a nosecup 33 is fixed is provided on the inner surface side in the central portion of lower portion 37.

Nosecup 33 is an annular seal member made of elastic soft rubber. Nosecup 33 is formed such that one end thereof is fixed to the nosecup holding portion, and the other end thereof is elastically in surface contact with a portion from an upper portion of the nose to both cheeks and the chin of the wearer, to thereby cover the mouth and the nose of the wearer in the mounted state. As described above, in the mounted state, an airtight breathing chamber is formed by nosecup 33 and the face of the wearer, and an intake gas is supplied to the breathing chamber.

A rotation mechanism 100 is attached to facepiece 11. Rotation mechanism 100 is located midway between gas supply and pressure detection lines 210 and 220 and front surface plate 31. One end of rotation mechanism 100 is connected to gas supply line 210 and pressure detection line 220. The other end of rotation mechanism 100 is connected to front surface plate 31. Facepiece 11 covers the face of the wearer. Facepiece 11 includes front surface plate 31 that is a transparent plate-like member having a size that can cover the face of the wearer, and rotation mechanism 100 passing through front surface plate 31 on either the right or left side of the wearer and being rotatable with respect to front surface plate 31.

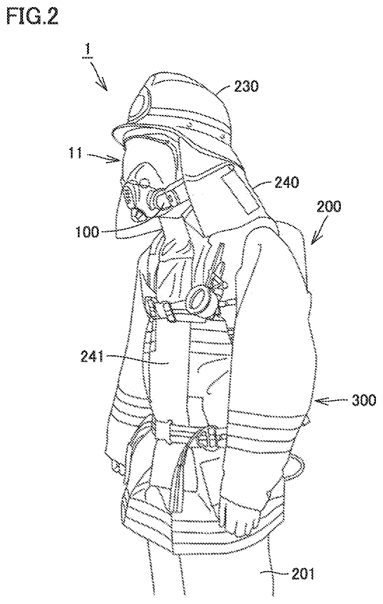

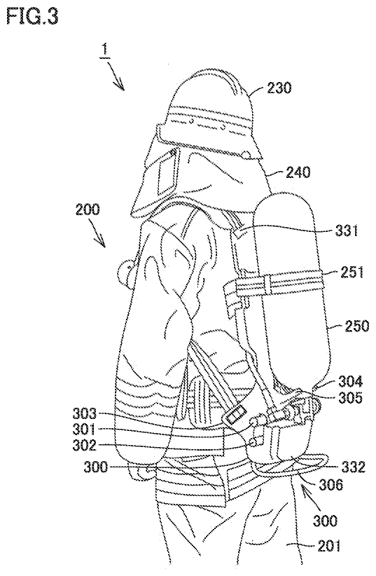

FIGS. 2 and 3 are perspective views of a wearer 201 wearing facepiece 11 and a back carrier 300 according to the embodiment. Wearer 201 is wearing a protective clothing 200. The head of wearer 201 is protected by a helmet 230, facepiece 11 and a neck guard (Shikoro) 240. Wearer 201 is carrying back carrier 300 on his back. A gas cylinder 250 is mounted on back carrier 300. A pressure demand valve is not provided on a body front surface 241 of protective clothing 200 or facepiece 11.

Back carrier 300 extends from an upper portion 331 to a lower portion 332. Gas cylinder 250 having a shape extending from upper portion 331 to lower portion 332 is fixed to back carrier 300 by a band 251. A tip of gas cylinder 250 is inserted between two rod-like portions 304 and 305 of back carrier 300. Air that is an oxygen-containing gas for breathing is, for example, compression-filled into gas cylinder 250 as an intake gas at a pressure higher than the atmospheric pressure.

Lower portion 332 of back carrier 300 is provided with a bypass valve switch 301 and a positive pressure locking switch 302. Bypass valve switch 301 is for guiding a high-pressure gas discharged from gas cylinder 250 to facepiece 11 without going through a pressure demand valve 400 and a regulator 460.

Positive pressure locking switch 302 is for stopping a positive pressure supplied from gas supply line 210 to facepiece 11. In a state where facepiece 11 is removed from wearer 201, supply of the gas from gas supply line 210 to facepiece 11 continues, and thus, the supplied gas is released to the atmosphere without being used. In order to prevent this, positive pressure locking switch 302 is operated to interrupt the supply of the gas from gas supply line 210, and thus, wasteful consumption of the gas can be suppressed.

Lower portion 332 of back carrier 300 is provided with a guard bar 306. Guard bar 306 protects lower portion 332 of back carrier 300 and allows back carrier 300 to stand on the ground on its own.

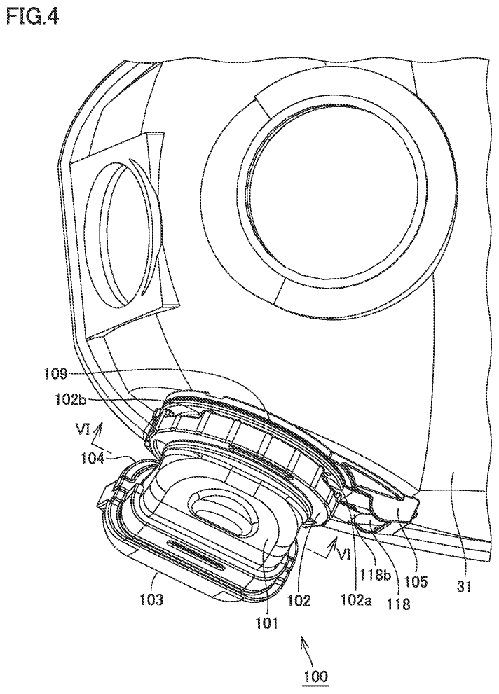

FIG. 4 is a perspective view of rotation mechanism 100 and front surface plate 31 to which rotation mechanism 100 is attached according to the embodiment. As shown in FIG. 4, rotation mechanism 100 includes a first main body 101. First main body 101 includes a circular portion and a rectangular portion. An upper main body cover 103 and a lower main body cover 104 engage with the rectangular portion of first main body 101.

A main body lock 102 engages with the circular portion of first main body 101. Main body lock 102 is provided with notches 102a, 102b and 102c. Main body lock 102 is rotatable with respect to front surface plate 31, together with first main body 101.

A base 105 is provided to be in contact with front surface plate 31. A plate spring 118 engages with base 105. An engagement portion 118b provided at a tip of plate spring 118 abuts against main body lock 102. Base 105 has an opening 105a.

A connector 109 is provided between base 105 and main body lock 102. Base 105 and connector 109 do not rotate with respect to front surface plate 31. When main body lock 102 is rotated, plate spring 118 fits into any one of notches 102a, 102b and 102c. As a result, the rotation of main body lock 102 can be stopped.

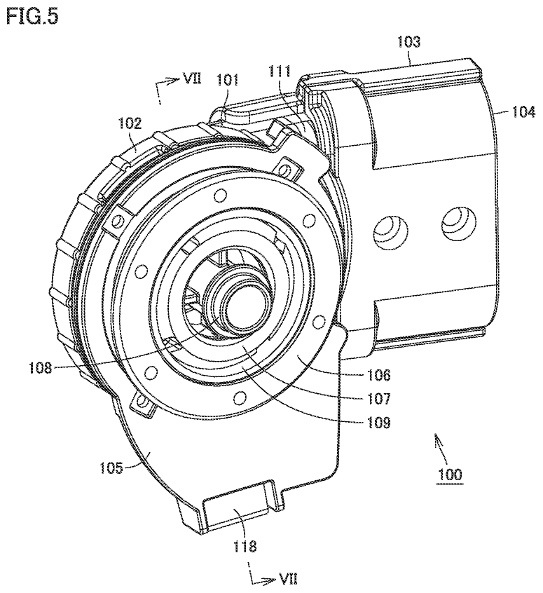

FIG. 5 is a perspective view of rotation mechanism 100 according to the embodiment. As shown in FIG. 5, a cylindrical member 108 is fitted into first main body 101. A main body screw 107, connector 109 and a connector screw 106 are present around cylindrical member 108. Base 105 is attached to connector 109.

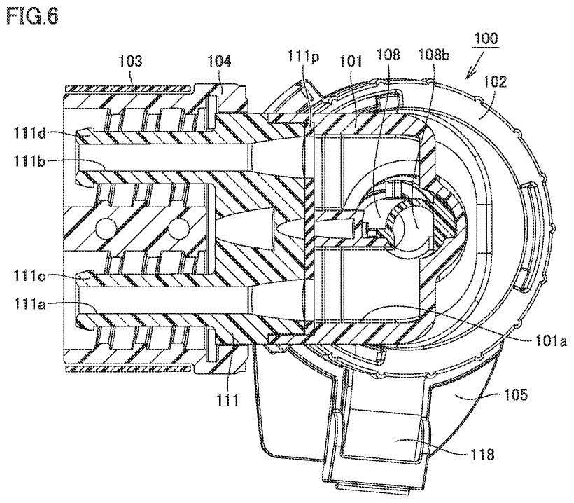

FIG. 6 is a cross-sectional view taken along line VI-VI in FIG. 4. As shown in FIG. 6, a second main body 111 is fitted into first main body 101. An internal space 101a is provided in first main body 101.

Second main body 111 is provided with protruding portions 111c and 111d extending in parallel with each other. Each of protruding portions 111c and 111d has a cylindrical shape, and internal spaces 111a and 111b thereof are provided to extend longitudinally. Internal spaces 111a and 111b communicate with internal space 101a of first main body 101.

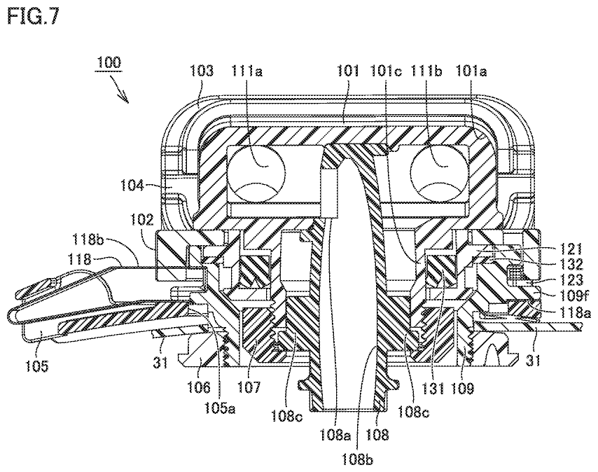

FIG. 7 is a cross-sectional view taken along line VII-VII in FIG. 5. As shown in FIG. 7, first main body 101 is sandwiched between upper main body cover 103 and lower main body cover 104. Internal spaces 111a and 111b each having a circular shape are open to internal space 101a of first main body 101.

Cylindrical member 108 is held in first main body 101. A projecting portion 108c of cylindrical member 108 is fitted into a cylindrical portion 101c of first main body 101. Cylindrical member 108 has a hollow shape and is located near a rotation axis of first main body 101.

Main body screw 107 is screwed onto an outer circumference of cylindrical portion 101c. A part of projecting portion 108c is sandwiched between main body screw 107 and cylindrical portion 101c, such that cylindrical member 108 is positioned in first main body 101.

Main body lock 102 is provided on the outer circumferential side of cylindrical portion 101c. A collar 121 and connector 109 are arranged between cylindrical portion 101c and main body lock 102. Base 105 is located on the lower side of a flange portion 109f. Connector screw 106 is screwed onto an end of connector 109. Front surface plate 31 is sandwiched between connector screw 106 and base 105.

Plate spring 118 includes an annular portion 118a sandwiched between connector 109 and base 105, and engagement portion 118b connected to annular portion 118a and engaging with main body lock 102. Plate spring 118 is made of an elastic material.

The airtightness between facepiece 11 and rotation mechanism 100 is implemented by the following structure.

Inner hoses 210a and 220a that form a part of metal corrugated tubes for pressure detection and for gas supply are connected to protruding portions 111c and 111d of second main body 111 shown in FIG. 6. Inner hoses 210a and 220a are made of rubber and the airtightness between protruding portions 111c and 111d and inner hoses 210a and 220a is maintained by contraction of the rubber.

Second main body 111 is coupled to first main body 101 by screwing, with a packing 111p interposed therebetween. The airtightness between first main body 101 and second main body 111 is maintained by a squeeze of packing 111p.

As shown in FIG. 7, a Y packing 131 is in contact with first main body 101 and collar 121. Y packing 131 is low in friction with respect to an outer diameter direction of the packing and can rotate while maintaining the airtightness between first main body 101 and collar 121. In addition, by attaching main body screw 107 to first main body 101 by screwing, a fall of cylindrical member 108 from first main body 101 is prevented.

A packing 132 is provided between collar 121 and connector 109. In addition, by rotating main body lock 102, collar 121 is pressed against connector 109 with packing 132 interposed therebetween, and thus, the airtightness is maintained.

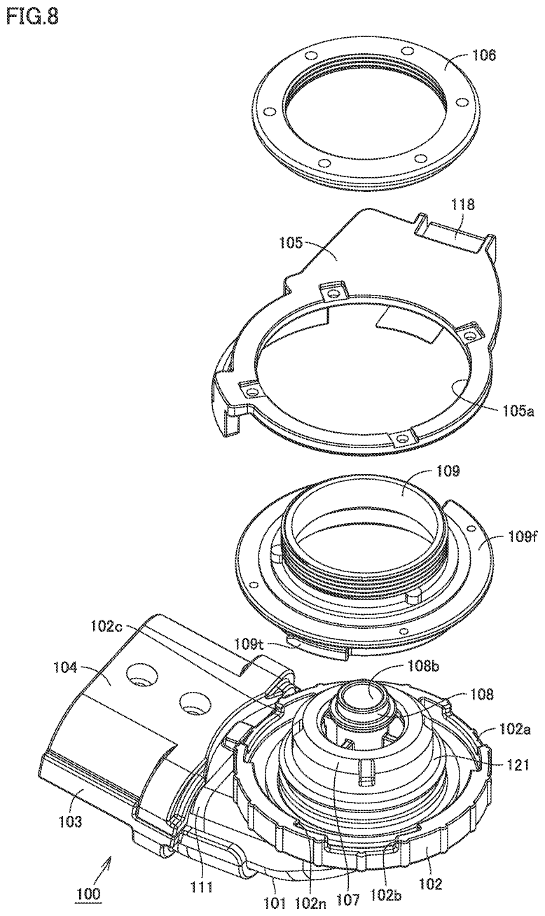

FIG. 8 is an exploded perspective view of rotation mechanism 100 according to the embodiment. As shown in FIG. 8, connector 109 is provided with a lug 109t extending circumferentially. Main body lock 102 is provided with a groove 102n extending circumferentially. Lug 109t is fitted into groove 102n. Groove 102n is provided with a stopper (not shown), and a circumferential end of lug 109t hits the stopper, such that main body lock 102 can rotate by a prescribed angle with respect to lug 109t. Rotation mechanism 100 includes base 105 as a first member fixed to facepiece 11 and having opening 105a, and cylindrical member 108 as a second member fitted into opening 105a to be rotatable with respect to base 105 and having a path, the path passing through front surface plate 31 and allowing the gas to flow therethrough. Rotation mechanism 100 further includes main body lock 102 as a rotatable third member, and plate spring 118 as a stop member fixed to base 105 and being capable of stopping the rotation of main body lock 102 by engaging with main body lock 102.

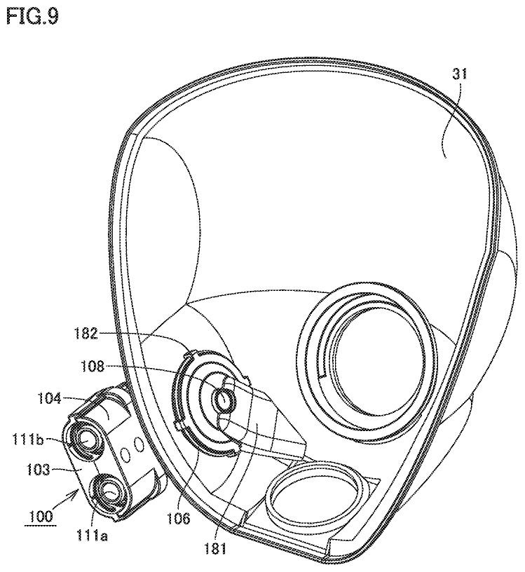

FIG. 9 is a perspective view of rotation mechanism 100 and front surface plate 31 to which rotation mechanism 100 is attached according to the embodiment. As shown in FIG. 9, connector screw 106 is provided on the inner side of front surface plate 31. A lug 182 of a deflector 181 engages with connector screw 106. Thus, deflector 181 is positioned in front surface plate 31.

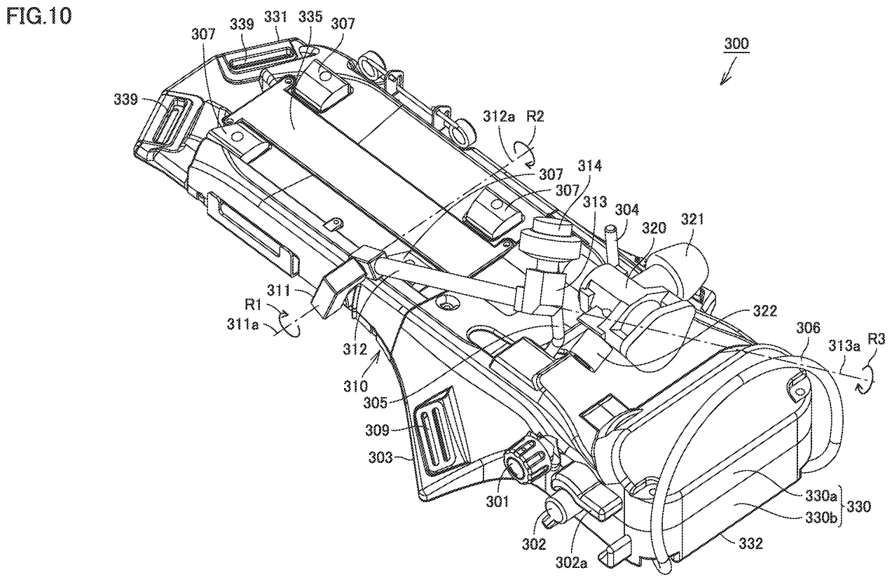

FIG. 10 is a perspective view of back carrier 300 according to the embodiment. As shown in FIG. 10, back carrier 300 includes a main body 330. Main body 330 includes a front plate 330a and a back plate 330b.

Main body 330 extends longitudinally from upper portion 331 to lower portion 332. Upper portion 331 is provided with a pair of belt holes 339. Upper portion 331 refers to an upper half in the longitudinal direction, and lower portion 332 refers to a lower half in the longitudinal direction. That is, main body 330 includes upper portion 331 located on the neck side of the wearer, and lower portion 332 located on the waist side of the wearer.

Main body 330 is provided with four stoppers 307 for positioning the cylinder. A lid 335 is provided between stoppers 307, and when lid 335 is removed, a recessed portion through which the gas supply line and the pressure detection line pass is exposed.

Main body 330 is provided with a first joint 311. First joint 311 is provided to be rotatable about a rotation axis 311a with respect to main body 330. A hose 312 is connected to first joint 311. Hose 312 is provided to be rotatable about a rotation axis 312a with respect to first joint 311. A second joint 313 is connected to hose 312. Second joint 313 is provided to be rotatable about a rotation axis 313a with respect to hose 312. A connector 314 provided at a tip of second joint 313 can be screwed onto a screwing portion 322 of a valve 320.

The pair of rod-like portions 304 and 305 extend in a direction away from front plate 330a. The pair of rod-like portions 304 and 305 are connected to guard bar 306 in main body 330. Rod-like portions 304 and 305 and guard bar 306 are manufactured by bending one rod.

Main body 330 is provided with a projecting portion 303. Projecting portion 303 is provided with a belt hole 309. Projecting portion 303 is provided closer to upper portion 331 with respect to bypass valve switch 301 and positive pressure locking switch 302.

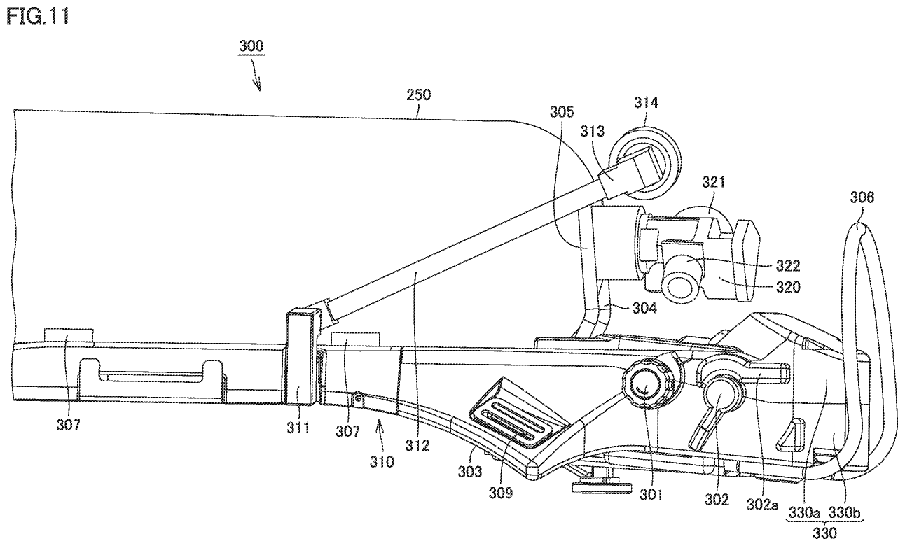

FIG. 11 shows a state in which gas cylinder 250 is mounted on back carrier 300. As shown in FIG. 11, by rotating first joint 311, a position of connector 314 in the longitudinal direction can be determined.

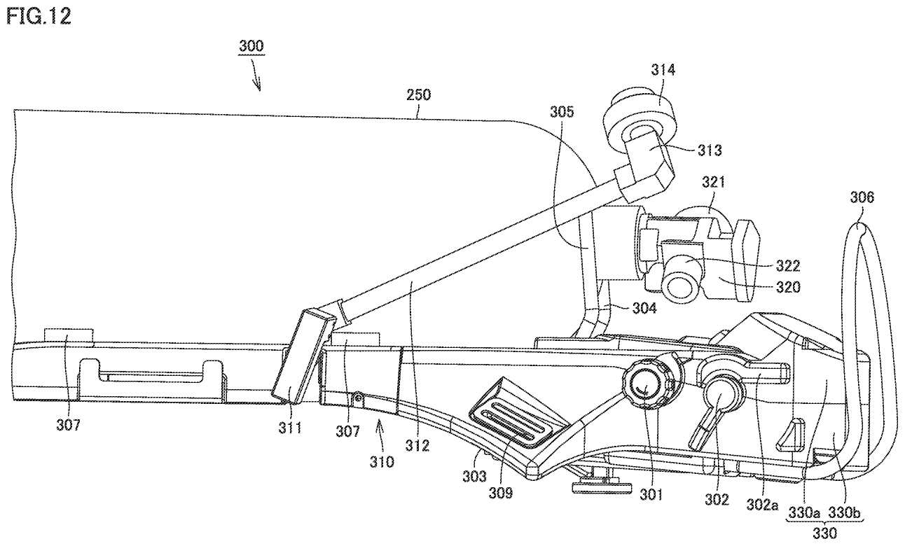

FIG. 12 shows a state in which gas cylinder 250 is mounted on back carrier 300. As shown in FIG. 12, by rotating hose 312, a position of connector 314 in a height direction can be determined.

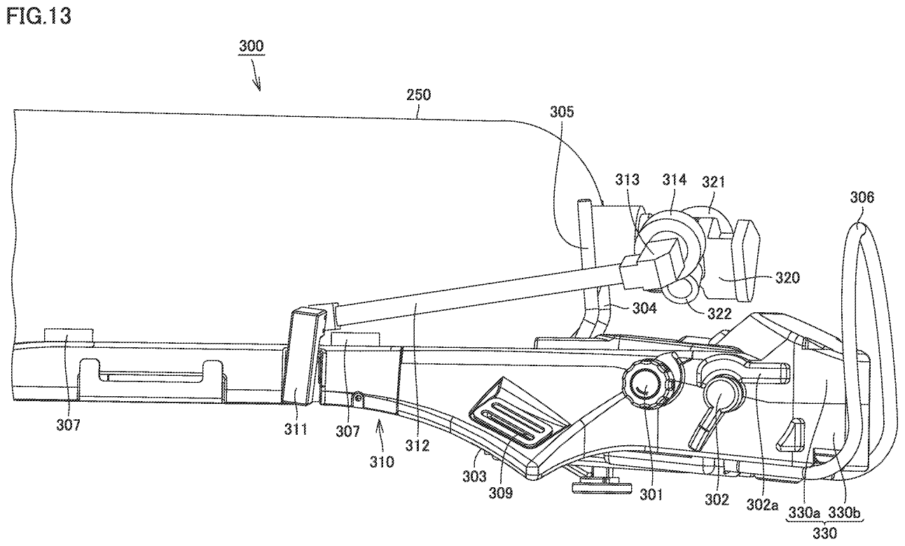

FIG. 13 shows a state in which gas cylinder 250 is mounted on back carrier 300. As shown in FIG. 13, by rotating second joint 313, an angle of connector 314 can be determined.

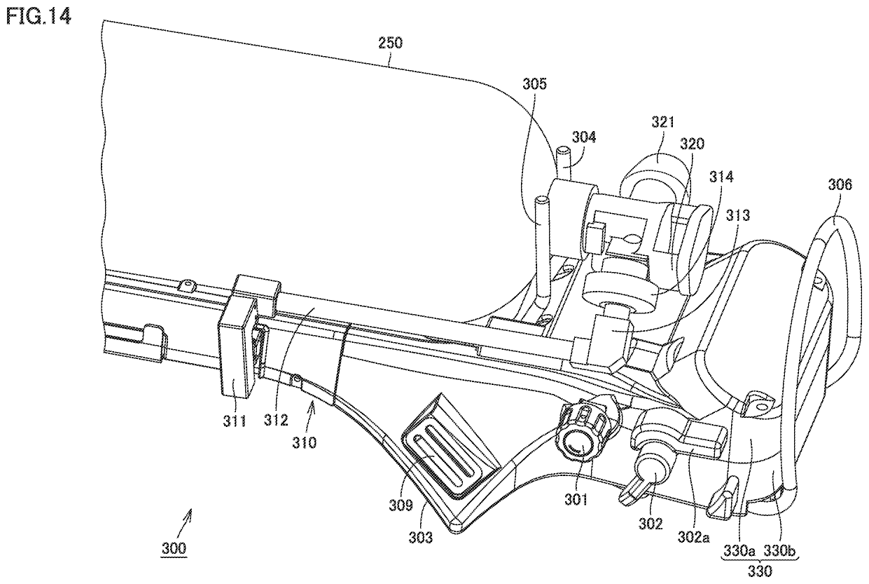

FIG. 14 shows a state in which gas cylinder 250 is mounted on back carrier 300. As shown in FIG. 14, by screwing connector 314 onto valve 320, valve 320 and connector 314 can be connected to each other.

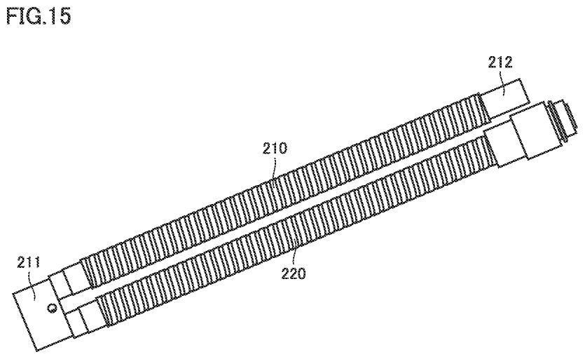

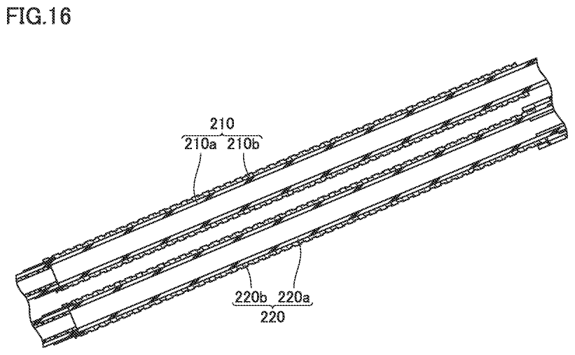

FIG. 15 shows gas supply line 210 and pressure detection line 220. FIG. 16 is a cross-sectional view of gas supply line 210 and pressure detection line 220. As shown in FIGS. 15 and 16, gas supply line 210 and pressure detection line 220 include inner hoses 210a and 220a made of rubber, and outer cases 210b and 220b covering inner hoses 210a and 220a, respectively. Outer cases 210b and 220b are flexible casing tubes, and are made of metal and bendable. As shown in FIG. 15, connectors 211 and 212 are provided at opposing ends of gas supply line 210 and pressure detection line 220.

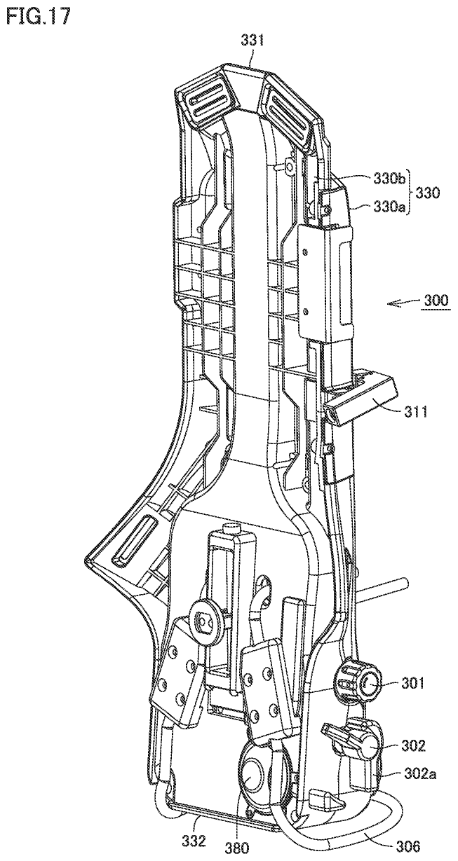

FIG. 17 is a perspective view of back carrier 300. As shown in FIG. 17, back plate 330b extends from upper portion 331 to lower portion 332 of back carrier 300. Lower portion 332 of back plate 330b is provided with a drain plug cover 380. A cover 302a covers positive pressure locking switch 302.

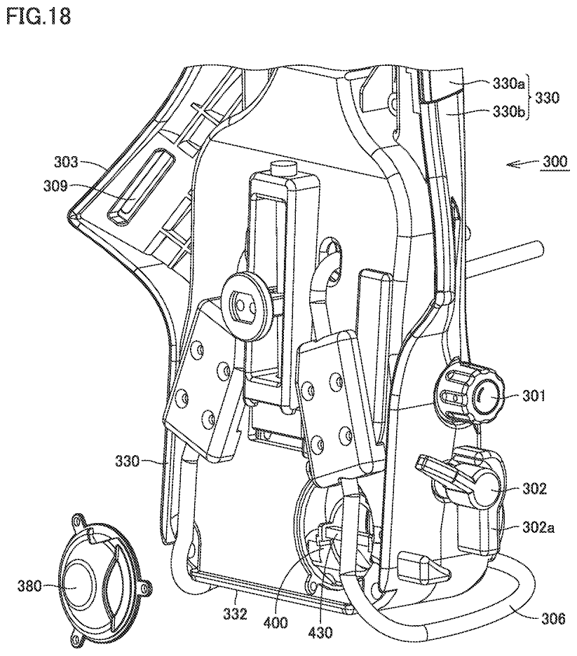

FIG. 18 is a perspective view of back carrier 300, with drain plug cover 380 removed. As shown in FIG. 18, when drain plug cover 380 is removed from back plate 330b, a drain plug 430 can be seen.

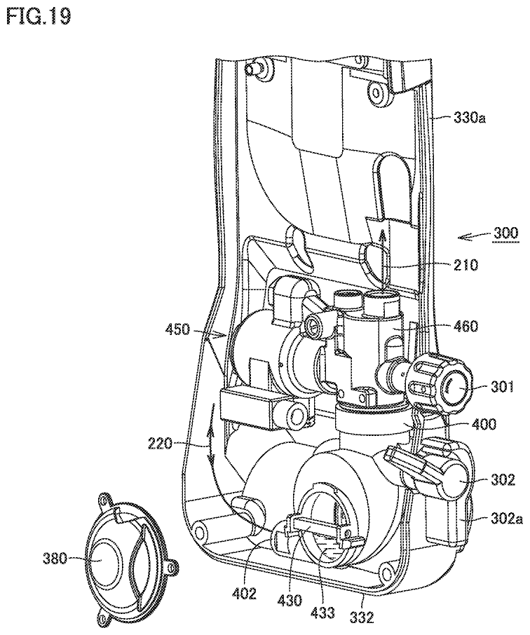

FIG. 19 is a perspective view showing an internal structure of back carrier 300, with back plate 330b removed. As shown in FIG. 19, an adjuster 450 is housed in front plate 330a. Adjuster 450 includes regulator 460 and pressure demand valve 400. Pressure demand valve 400 is provided with drain plug 430. Water 433 accumulated in pressure demand valve 400 can be discharged from drain plug 430. Regulator 460 and pressure demand valve 400 are provided in lower portion 332 of the main body.

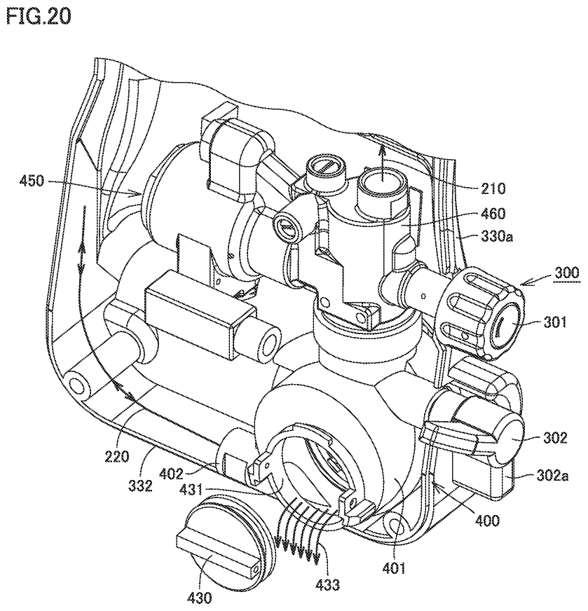

FIG. 20 is a perspective view showing an internal structure of back carrier 300, with drain plug 430 removed from a case 401. As shown in FIG. 20, case 401 is provided with an opening 431. Drain plug 430 is provided to fit into circular opening 431.

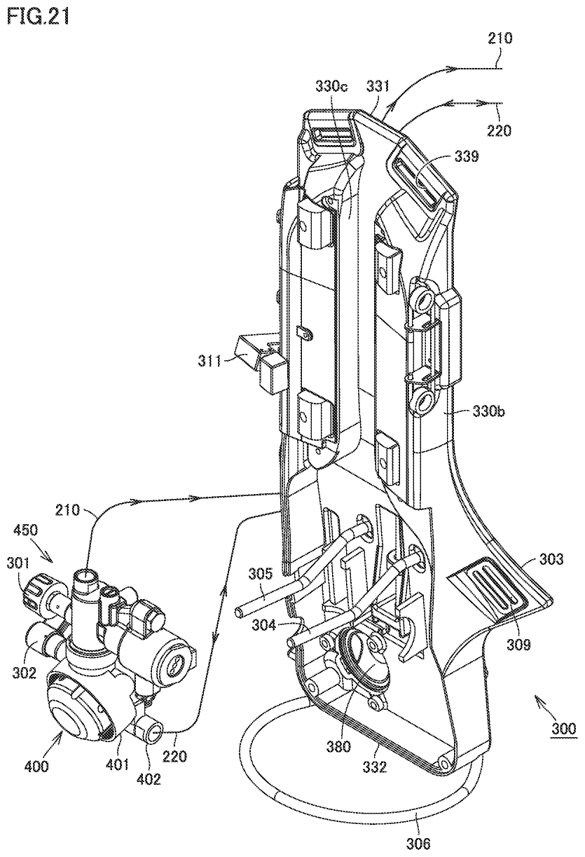

FIG. 21 is a perspective view showing an internal structure of back carrier 300, with adjuster 450 removed from back plate 330b. As shown in FIG. 21, back plate 330b is provided with a groove 330c extending from upper portion 331 to lower portion 332. Gas supply line 210 and pressure detection line 220 are arranged in groove 330c. When water enters pressure detection line 220, the water comes to a dead end at case 401, and thus, the water is likely to accumulate in this portion. By providing drain plug 430, water 433 can be easily discharged.

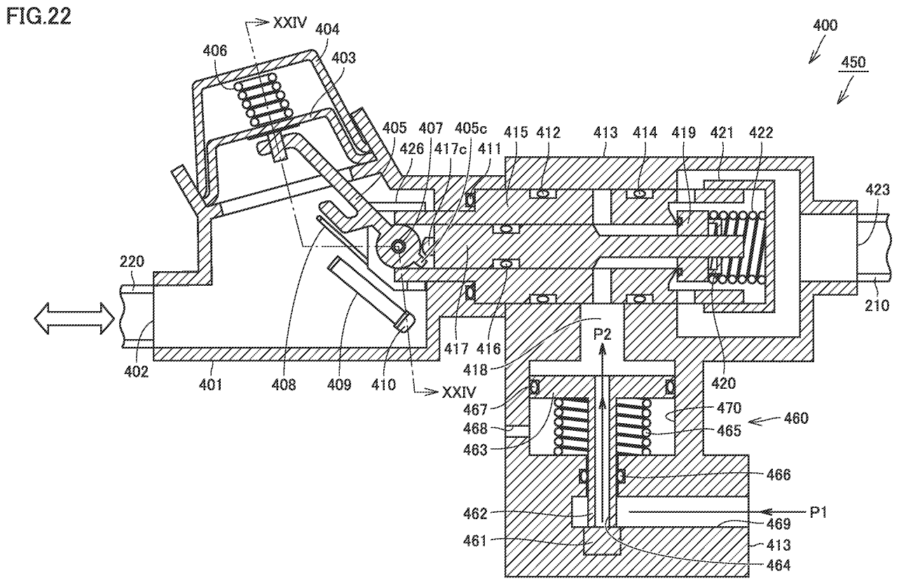

FIG. 22 is a cross-sectional view showing an internal structure of pressure demand valve 400. As shown in FIG. 22, pressure demand valve 400 includes an adjuster main body 413. Adjuster main body 413 includes an inlet portion 418 and a gas supply port 423 that is an outlet.

A pressure demand valve main body 415 is fitted into adjuster main body 413. Pressure demand valve main body 415 cannot move with respect to adjuster main body 413. A shaft 417 is slidably fitted into a cylindrical portion of pressure demand valve main body 415.

Case 401 is in contact with adjuster main body 413. Case 401 is provided with a diaphragm 403. A positive pressure spring 406 is provided on one side of diaphragm 403, and a lever 405 is provided on the other side of diaphragm 403.

Case 401 is provided with a pressure detection port 402. Pressure detection line 220 is inserted into pressure detection port 402. A positive pressure locking shaft 410 is arranged in case 401. A second auxiliary lever 409 is connected to positive pressure locking shaft 410. A first auxiliary lever 408 is attached to a cap 426. Positive pressure locking shaft 410 is connected to positive pressure locking switch 302.

Pressure demand valve 400 has the function of supplying air having a pressure slightly higher than the atmospheric pressure to facepiece 11 in accordance with breathing. Pressure demand valve 400 implements the above-described function by the following structure.

Air having a medium pressure (1 MPa or less) flows from inlet portion 418 of adjuster main body 413 to pressure demand valve main body 415. The medium-pressure air is enclosed between pressure demand valve main body 415 and adjuster main body 413 by a first O ring 412 and a second O ring 414.

Shaft 417 runs within pressure demand valve main body 415 and a valve body 419 is coupled to shaft 417 by a nut 420. Valve body 419 is a composite member of metal and rubber. A rubber portion of valve body 419 is pressed against a sheet surface of pressure demand valve main body 415 by a valve spring 422 fixed by a spring receiver 421, and thus, the flow of the medium-pressure air is stopped. In addition, a U seal 416 is attached to shaft 417 to prevent the medium-pressure air from flowing to the case 401 side.

Case 401 and pressure demand valve main body 415 are coupled to each other and an O ring 411 is provided in the coupled portion to prevent a pressure in case 401 from flowing to the atmosphere.

Case 401 connects to facepiece 11 through pressure detection port 402, and pressure fluctuations in facepiece 11 that occur due to breathing are transmitted into case 401. Diaphragm 403 is made of rubber and sandwiched between a cover 404 and case 401, and thus, the air in case 401 does not leak to the cover 404 side.

Since case 401 is connected to facepiece 11 through pressure detection line 220, the pressure in case 401 fluctuates due to breathing of wearer 201. When the pressure in case 401 fluctuates, a shape of diaphragm 403 is deformed in response to the pressure fluctuation.

Lever 405 is connected to diaphragm 403, and when diaphragm 403 is deformed, lever 405 rotates about a rotation shaft 407. Rotation shaft 407 is fixed by cap 426, and cap 426 is coupled to pressure demand valve main body 415.

Adjuster main body 413 forms a case (main body) of regulator 460. As a result, pressure demand valve 400 and regulator 460 are formed integrally with adjuster 450. In other words, back carrier 300 includes adjuster 450 including regulator 460 and pressure demand valve 400 attached to main body 330 and integrated with each other.

Regulator 460 decompresses high-pressure air having a pressure P1 into medium-pressure air having a pressure P2. A high pressure valve sheet 461 is embedded in adjuster main body 413. A shaft 462 of a piston 463 is in contact with high pressure valve sheet 461. Piston 463 is housed in a decompression chamber 470. A spring 465 presses piston 463. When pressure P2 on the pressure demand valve 400 side becomes smaller, the force of pressure P2 pressing piston 463 becomes weaker and piston 463 moves from the position shown in FIG. 22 in a direction approaching shaft 417. As a result, shaft 462 moves away from high pressure valve sheet 461 and the air flows through a passage 464 provided in shaft 462. When pressure P2 at inlet portion 418 becomes higher due to the air, the force of pressure P2 pressing piston 463 becomes stronger and shaft 462 is pressed against high pressure valve sheet 461.

An O ring 466 is provided between shaft 462 and adjuster main body 413. An O ring 467 is provided between a head portion of piston 463 and adjuster main body 413. The airtightness is maintained by these O rings 466 and 467.

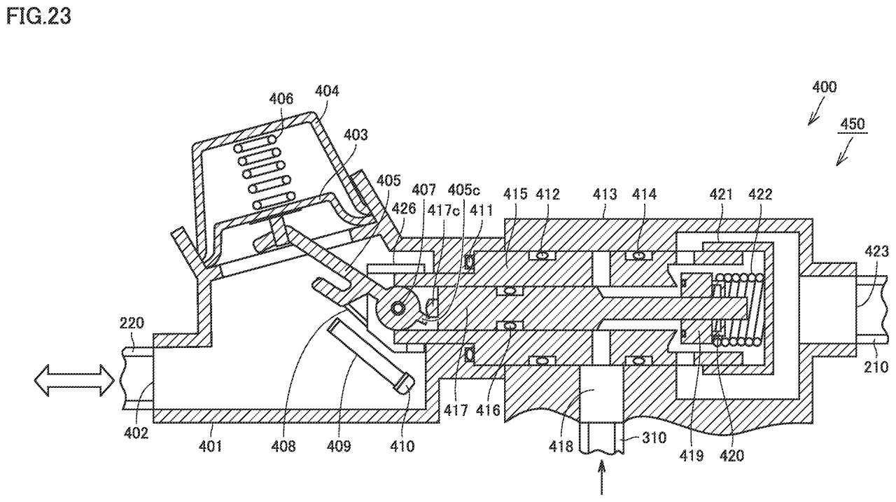

FIG. 23 is a cross-sectional view showing a state in which the medium-pressure air is flowing to gas supply port 423 in pressure demand valve 400 in accordance with an amount of breathing. As shown in FIG. 23, when diaphragm 403 fluctuates due to breathing, lever 405 rotates. An end 405c of lever 405 presses an end 417c of shaft 417. Valve body 419 moves in conjunction with shaft 417 and a gap is generated between pressure demand valve main body 415 and valve body 419. As a result, the medium-pressure air flows to gas supply port 423 in accordance with the amount of breathing.

Gas supply port 423 connects to facepiece 11 through gas supply line 210. The pressure in facepiece 11 fluctuates due to the air supplied to facepiece 11, and the pressure fluctuation is detected at pressure detection port 402 through pressure detection line 220, and diaphragm 403 moves due to the pressure fluctuation.

Positive pressure spring 406 fixed by cover 404 applies a load corresponding to an amount of compression to diaphragm 403. Cover 404 is provided with a hole through which the atmospheric air is transmitted, and thus, positive pressure spring 406 and the neighborhood thereof have the atmospheric pressure. Due to the load applied by positive pressure spring 406, the pressure in case 401 becomes higher than the atmospheric pressure.

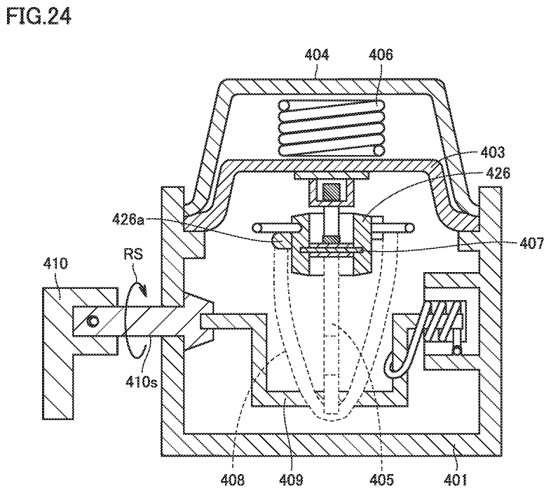

FIG. 24 is a cross-sectional view taken along line XXIV-XXIV in FIG. 22. When a breathing apparatus is not used, positive pressure locking shaft 410 is rotated. When positive pressure locking shaft 410 is rotated in a direction indicated by an arrow RS, second auxiliary lever 409 rotates in conjunction with positive pressure locking shaft 410 and a shaft 410s. Due to the rotation of second auxiliary lever 409, second auxiliary lever 409 pushes up first auxiliary lever 408 and first auxiliary lever 408 runs onto a protrusion 426a provided on cap 426, such that a position of first auxiliary lever 408 is fixed. Since the position of first auxiliary lever 408 is fixed, lever 405 does not allow first auxiliary lever 408 to climb over protrusion 426a of cap 426 and return to the original position, using only the force of positive pressure spring 406 transmitted through diaphragm 403, and thus, lever 405 is fixed. Since lever 405 is fixed, valve body 419 does not open and the air does not flow into facepiece 11 through gas supply port 423.

When the pressure in case 401 is reduced by air intake in this state, the force transmitted through diaphragm 403 increases and first auxiliary lever 408 climbs over protrusion 426a of cap 426 that fixes first auxiliary lever 408, and thus, the fixation is released.

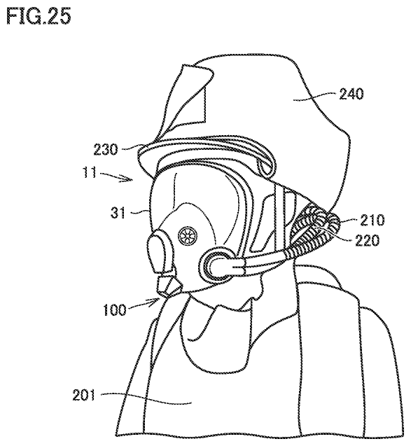

FIG. 25 shows wearer 201, with neck guard (Shikoro) 240 lifted up. Since neck guard (Shikoro) 240 is lifted down in FIGS. 2 and 3, rotation mechanism 100 cannot be seen. However, since neck guard (Shikoro) 240 is lifted up in FIG. 25, rotation mechanism 100, gas supply line 210 and pressure detection line 220 are exposed. Gas supply line 210 and pressure detection line 220 are preferably arranged on the left side of wearer 201. This is because wearer 201 carries a fire hose on his right shoulder. If gas supply line 210 and pressure detection line 220 are provided on the right side, gas supply line 210 and pressure detection line 220 interfere with the fire hose.

A structure for rotating and locking rotation mechanism 100 with respect to facepiece 11 is implemented by the following. First, annular portion 118a of plate spring 118 is attached to base 105.

Base 105 is fitted to connector 109. When main body lock 102 is rotated, any one of notches 102a, 102b and 102c of main body lock 102 engages with engagement portion 118b of plate spring 118. As a result, main body lock 102 is no longer rotated.

In order to rotate main body lock 102, engagement portion 118b is pressed down toward the base 105 side. This releases the engagement between engagement portion 118b and any one of notches 102a, 102b and 102c. As a result, main body lock 102 can be rotated.

A breathing apparatus 1 has the following features.

Adjuster 450, which is a component of breathing apparatus 1, is arranged in back carrier 300. Thus, as compared with the case in which adjuster 450 is arranged on body front surface 241 of wearer 201, adjuster 450 is not disconnected from the position where adjuster 450 is arranged, while wearer 201 is performing operations.

In back carrier 300, an exposed portion of arranged adjuster 450 is covered with front plate 330a, which is a separate component. In addition, guard bar 306, which is a self-standing fitting that is not in direct contact with adjuster 450, is provided.

Adjuster 450 has such a structure that the regulating portion (regulator 460) that regulates the high-pressure air and the supply portion (pressure demand valve 400) that supplies an appropriate amount of the regulated air to the wearer in accordance with an amount of breathing are integrated with each other.

Gas supply line 210 and pressure detection line 220, which are hoses for breathing (breathing hoses) that couple facepiece 11 to adjuster 450, connect to facepiece 11 from the back of the wearer without going through body front surface 241.

A part of gas supply line 210 and pressure detection line 220 are housed in back carrier 300. In conjunction with the movement of the neck of wearer 201, gas supply line 210 and pressure detection line 220 extend and contract by a distance of the movement of the neck.

The connection fitting (rotation mechanism 100) that connects facepiece 11 to gas supply line 210 and pressure detection line 220 is rotatable with respect to facepiece 11, while maintaining a protected state from the outside air in facepiece 11 when breathing apparatus 1 is worn.

The hose that connects breathing apparatus 1 to the high-pressure air container (gas cylinder 250) has such a structure that the fitting for connection of the hose (hereinafter, high pressure hose connection fitting) has the multiple rotation axes and eccentricity during rotation allows connection to gas cylinders having different sizes.

At a site of a fire, quick and safe operations are required because of operations in a dangerous area. However, smoke produced by the fire impairs visibility. If visibility on the foot side becomes poor, quick and safe operations become difficult because there is a possibility of falling down in a site having a level difference. If adjuster 450, gas supply line 210 and pressure detection line 220 are provided on the body front surface in this situation, downward visibility becomes poor due to the components of breathing apparatus 1. In the present breathing apparatus, adjuster 450 is not provided on the body front surface, and gas supply line 210 and pressure detection line 220 are connected to facepiece II from the back of the body. Therefore, there are no components that obstruct downward visibility, and thus, visibility does not become poor.

When breathing apparatus 1 is used for operations in a narrow space, movements such as lying on wearer's stomach, squatting, and holding a ladder may be required in some cases. If adjuster 450, gas supply line 210 and pressure detection line 220 are provided on body front surface 241, ease of operation is inhibited due to interference with the components.

In breathing apparatus 1 according to the embodiment, adjuster 450, gas supply line 210 and pressure detection line 220 are not provided on the body front surface. Therefore, wearer 201 can bring his body into close contact with the ground or a ladder, and thus, ease of operation is enhanced.

Breathing apparatus 1 according to the embodiment is provided with the component that covers the exposed portion of adjuster 450, and guard bar 306 which is a self-standing fitting that is not in direct contact with adjuster 450. Therefore, breathing apparatus 1 according to the embodiment has a structure for protecting adjuster 450 against impacts caused by collision and falling.

By integrally forming adjuster 450, the hose (hereinafter, medium pressure hose) that connects regulator 460 to pressure demand valve 400 becomes unnecessary. Since the medium pressure hose is made of rubber, the medium pressure hose deteriorates over time. However, since the hose becomes unnecessary, the maintainability is enhanced. In addition, since the medium pressure hose becomes unnecessary, adjuster 450 is reduced in size.

When wearer 201 looks right and left and up and down, or when wearer 201 takes various postures, the neck of wearer 201 moves. When the neck moves beyond the elasticity of the hose, the hose is pulled by the movement of the neck. When the hose is designed to flex with the movement of the neck taken into consideration, wearer 201 may be caught by the hose during operation if the hose is excessively exposed on the body front surface.

In breathing apparatus 1 according to the first embodiment, gas supply line 210 and pressure detection line 220 extend and contract in accordance with the movement of the neck, and thus, stress on the neck portion is relieved. In addition, gas supply line 210 and pressure detection line 220 are housed in back carrier 300, and thus, excessive exposure of the hose is suppressed and ease of operation is enhanced.

Since rotation mechanism 100 rotates, the up and down and right and left movement of the neck is followed when breathing apparatus 1 is worn, and thus, stress on the neck portion is relieved.

In addition, when water enters gas supply line 210, pressure detection line 220 and adjuster 450 through the facepiece as a result of assisted water spraying or the like, in a state where breathing apparatus 1 is worn and facepiece 11 is taken off (standby state), the water causes a failure of breathing apparatus 1 due to corrosion of the components or freezing under low temperature. Since rotation mechanism 100 rotates, facepiece 11 can be rotated in the standby state so as to be oriented in a direction that prevents entry of the water of assisted water spraying.

Gas cylinder 250 varies in internal volume depending on an amount of carried air, and thus, varies in size of the container itself. In contrast, the hose connecting to gas cylinder 250 generally has a multilayer structure in order to withstand the high-pressure air, and thus, the hose itself is inferior in elasticity. Therefore, when the hose is connected to gas cylinders 250 having different sizes, it is necessary to provide a degree of freedom for the high pressure hose connection fitting, or to adjust a position where each gas cylinder 250 is fixed to the back carrier. In the case of providing the degree of freedom for the high pressure hose connection fitting, sliding of the high pressure hose connection fitting for position adjustment applies the frictional force due to a mass of the component and a configuration of a component connected to the high pressure hose connection fitting. Since connection to gas cylinder 250 is performed whenever breathing apparatus 1 is used, the repeated action leads to stress of wearer 201 and device wear.

A high pressure hose connection fitting 310, which is a guide path that guides the gas of gas cylinder 250 from outside main body 330 to inside main body 330, is provided between gas cylinder 250 and regulator 460. High pressure hose connection fitting 310 includes first joint 311, hose 312 and second joint 313. High pressure hose connection fitting 310 is rotatable along a plurality of axes. By providing the multiple rotation axes to high pressure hose connection fitting 310 for connection, the connectivity to gas cylinder 250 is enhanced. In the present embodiment, high pressure hose connection fitting 310 has three rotation axes 311a, 312a and 313a. However, high pressure hose connection fitting 310 may have more or fewer rotation axes.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 breathing apparatus; 11 facepiece; 21 facepiece main body; 22 head strap; 31 front surface plate; 32 support; 33 nosecup; 36, 331 upper portion; 37, 332 lower portion; 100 rotation mechanism; 101 first main body; 101a, 111a, 111b internal space; 101c cylindrical portion; 102 main body lock; 102a, 102b, 102c notch; 102n, 330c groove; 103 upper main body cover; 104 lower main body cover; 105 base; 106 connector screw; 107 main body screw; 108 cylindrical member; 108c, 303 projecting portion; 109, 314 connector; 109f flange portion; 109t, 182 lug; 111 second main body; 111c, 111d protruding portion; 118 plate spring; 118a annular portion; 118b engagement portion; 121 collar; 181 deflector; 200 protective clothing; 201 wearer; 210 gas supply line; 210a, 220a inner hose; 210b, 220b outer case; 211, 212 connector; 220 pressure detection line; 230 helmet; 240 neck guard (Shikoro); 241 body front surface; 250 gas cylinder; 251 band; 300 back carrier; 301 bypass valve switch; 302 positive pressure locking switch; 302a cover; 304, 305 rod-like portion; 306 guard bar; 307 stopper; 309, 339 belt hole; 310 high pressure hose connection fitting; 311 first joint; 311a, 312a, 313a, 407 rotation axis; 312 hose; 313 second joint; 320 valve; 322 screwing portion; 330 main body; 330a front plate; 330b back plate; 335 lid; 380 drain plug cover; 400 pressure demand valve; 401 case; 402 pressure detection port; 403 diaphragm; 404 cover; 405 lever; 406 positive pressure spring; 408 first auxiliary lever; 409 second auxiliary lever; 410 positive pressure locking shaft; 411, 412, 414 ring; 413 adjuster main body; 415 pressure demand valve main body; 416 seal; 417 shaft; 418 inlet portion; 419 valve body; 420 nut; 422 valve spring; 423 gas supply port; 426 cap; 430 drain plug; 431 opening; 433 water; 450 adjuster; 460 regulator.

1. A back carrier having a gas cylinder attached thereto, and carried on wearer's back, the back carrier comprising:
a main body to which the gas cylinder is attached; and
an adjuster including a regulator and a pressure demand valve attached to the main body and integrated with each other.

2. The back carrier according to claim 1, wherein
the main body includes an upper portion located on neck side of a wearer and a lower portion located on waist side of the wearer, and
the regulator and the pressure demand valve are provided in the lower portion of the main body.

3. The back carrier according to claim 2, wherein
the main body is provided with a groove extending from the upper portion to the lower portion, and
a pressure detection line that detects pressure in a facepiece and a gas supply line that feeds gas into the facepiece are arranged in the groove.

4. The back carrier according to claim 1, wherein
a guide path that guides gas of the gas cylinder from outside the main body to inside the main body is provided between the gas cylinder and the regulator, and
the guide path is rotatable along plural axes.

5. A breathing apparatus comprising:
the back carrier as described in claim 1; and
a facepiece supplied with gas from the back carrier and covering a face of a wearer.
